(19) United States
(12) Patent Application Publication
(10) Pub. No.: US 2002/0082960 A1
(43) Pub. Date: Jun. 27, 2002

(54) Internet-based customer referral system

(76) Inventor: James Francis Goedken, Palatine, IL (US)

Correspondence Address: JAMES F. GOEDKEN, 1413 N. LARKSPUR LN., PALATINE, IL, 60067, US

(21) Appl. No.: 09/805,520

(22) Filed: Mar. 13, 2001

Related U.S. Application Data
(60) Provisional application No. 60/188,864, filed on Mar. 13, 2000.
(60) Provisional application No. 60/190,974, filed on Mar. 21, 2000.

(51) Int. Cl. G06F 17/60

(52) U.S. Cl. 705/35

(57) ABSTRACT

A method and apparatus for a customer to purchase a product or service from a merchant website on the Internet is provided. The customer selects a hyperlink from an associate web page that is related to a merchant supplied product. The associate server then acts as a middleman between the merchant server and the customer computer in a manner that permits the associate to automatically earn a commission for and personally track each electronic referral and/or sale. The requested web page need not contain any hyperlinks to the merchant server and the associate need not register with the merchant or receive an associate ID from the merchant.

### RELATED APPLICATIONS

This application claims priority from provisional application serial No. 60/188,864 filed Mar. 13, 2000 and provisional application serial No. 60/190,974 filed Mar. 21, 2000.

### TECHNICAL FIELD

The disclosed material relates in general to conducting electronic commerce, and, in particular, to methods and apparatus for a customer to purchase a product or service from a merchant with the assistance of an associate, wherein the associate earns a commission for the electronic sale.

### BACKGROUND

The Internet provides a unique opportunity for merchants in one product category to cooperate with merchants in another non-competing product category. For example, a news provider reporting on a kayak race is in a good position to recommend a book on kayaking from a book seller. Similarly, an entertainment website listing concerts may link to a website where a band's compact disk (CD) may be purchased. Even small hobbyists with special interest websites often refer people to retailers with related products.

One such system is disclosed in U.S. Pat. No. 6,029,141, issued on Feb. 22, 2000 to Bezos et al. and assigned to Amazon.com (hereinafter referred to as the '141 system and incorporated herein by reference). The '141 system allows associates to earn a commission for referring customers to a merchant's website. However, the '141 system has certain significant drawbacks. First, the '141 system requires associates to register with each merchant website to which they intend to refer customers. Although the '141 system allows associates to register electronically, registration may be time consuming and cumbersome. Although not taught by the '141 system, according to the techniques described herein, multiple merchants may be used by a single associate. In such an instance, the burden of registration increases.

One of the reasons this registration process is required in the '141 system is to assign each associate a unique associate ID which is used to identify the associate for commission payment purposes. The '141 system requires the associate ID to be transmitted from the merchant to the associate, then from the associate to the customer, then from the customer back to the merchant. The associate ID is transmitted from the merchant to the associate during the registration process discussed above. The associate ID is transmitted from the associate to the customer when the customer requests a web page from the associate which contains a specially formatted merchant hyperlink. And, the associate ID is transmitted from the customer back to the merchant when the customer selects the special merchant hyperlink.

Second, the '141 system requires associates to embed hyperlinks in their web pages which connect customers directly to the merchant. Typically, associates do not want to send their clients off to another website because then the associate loses control. Once the customer leaves the associate's website the associate is unable to directly track the customers selections. Tracking a customer's selections is important for improving a website and accounting for commissions which are owed. Further, once the customer leaves the associate's website he is less likely to conduct additional business with that associate than if the customer had remained on site. Still further, the associate may wish to employ more than one merchant for supplying associated products (e.g., based on price, delivery, availability, etc.). By keeping the associate in control of the transaction, the associate may supply the customer from more than one merchant while presenting a common user interface to the customer.

### BRIEF DESCRIPTION OF THE DRAWINGS

These and other features and advantages of the disclosed system will be apparent to those of ordinary skill in the art in view of the detailed description of the preferred embodiments which is made with reference to the drawings, a brief description of which is provided below.

FIG. 1 is a high level block diagram of a computer network including a customer computer, an associate server, and a merchant server.

FIG. 2 is a more detailed block diagram of the customer computer of FIG. 1.

FIG. 3 is a more detailed block diagram of the associate server of FIG. 1.

FIG. 4 is a more detailed block diagram of the merchant server of FIG. 1.

FIG. 5 is a data flow diagram illustrating a communication sequence for purchasing a product from a merchant on the Internet with the assistance of an associate.

FIG. 6 is a another data flow diagram illustrating a communication sequence for purchasing a product from a merchant on the Internet with the assistance of an associate.

FIG. 7 is a data flow diagram illustrating a communication sequence for purchasing a product from one of a plurality of merchants on the Internet with the assistance of an associate.

### DETAILED DESCRIPTION OF EXEMPLARY EMBODIMENTS

In general, a system which allows a customer to purchase a product or service from a merchant website on the Internet is described below. The customer selects a hyperlink from an associate web page that is related to a merchant supplied product or service. The associate server then acts as a middleman between the merchant server and the customer computer for at least part of the transaction. The associate automatically earns a commission for each referral and/or sale, and the associate server may track each electronic referral and/or sale because the associate server is handling some or all of the messages associated with the referral and/or sale. The web page requested by the customer need not contain any hyperlinks to the merchant server and the associate need not register with the merchant or receive an associate ID from the merchant.

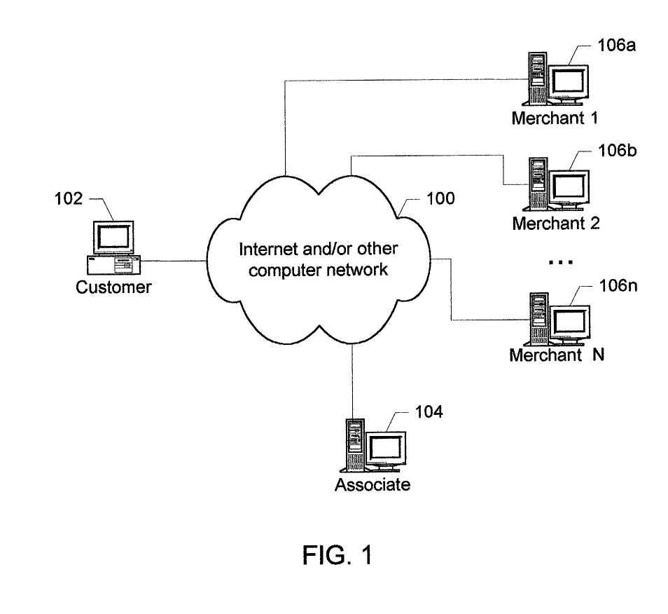

A high level block diagram of a computer network 100 including a customer computer 102, an associate server 104, and one or more merchant servers 106 is illustrated in FIG. 1. Although the computer network 100 described herein is the Internet, a person of ordinary skill in the art will readily appreciate that any present or future computer network could be used without departing from the scope and spirit of the present invention. Typically, the customer computer 102 is a personal computer connected to the Internet. However, any computing device capable of network communication may be used. For example, a television, personal digital assistant (PDA), or wireless telephone may be used. Although, for simplicity in explanation, only one customer computer 102 is described herein, it is understood that many customer computers 102 may be connected in a typical system.

Typically, the associate server 104 and the merchant server 106 are more powerful computers (or collections of computers) with large storage capacities, fast processors, and the ability to communicate with multiple devices on the Internet 100 simultaneously. Although, for simplicity in explanation, only one associate server 104 is described herein, it is understood that many associate servers 104 may be connected in a typical system.

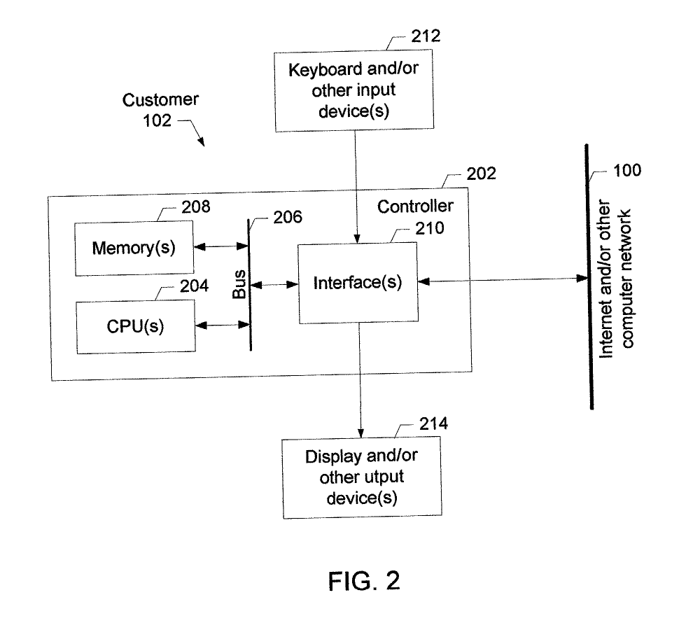

A more detailed diagram of the customer computer 102, is illustrated in FIG. 2. A controller 202 in the customer computer 102 preferably includes a central processing unit 204 electrically coupled by an address/data bus 206 to a memory device 208 and an interface circuit 210. The CPU 204 may be any type of well known CPU, such as an Intel Pentium™ processor. The memory device 208 preferably includes volatile memory, such as a random-access memory (RAM), and non-volatile memory, such as a read only memory (ROM) and/or a magnetic disk. The memory device 208 stores a software program that may implement all or part of the method described below. This program is executed by the CPU 204, as is well known. Some of the steps described in the method below may be performed manually or without the use of the customer computer 102.

The interface circuit 210 may be implemented using any data transceiver, such as a Universal Serial Bus (USB) transceiver, an Ethernet transceiver, and/or a modem. One or more input devices 212 may be connected to the interface circuit 210 for entering data and commands into the controller 202. For example, the input device 212 may be a keyboard, mouse, touch screen, track pad, track ball, isopoint, and/or a voice recognition system.

An output device 214 may also be connected to the controller 202 via the interface circuit 210. Examples of output devices 214 include cathode ray tubes (CRTs), liquid crystal displays (LCDs), speakers, and/or printers. The output device 212 generates visual displays of data generated during operation of the customer computer 102. The visual displays may include prompts for human operator input, run time statistics, calculated values, and/or detected data. The customer computer 102 may also exchange data with other computing devices via a connection to the Internet 100. The connection may be any type of network connection, such as an Ethernet connection.

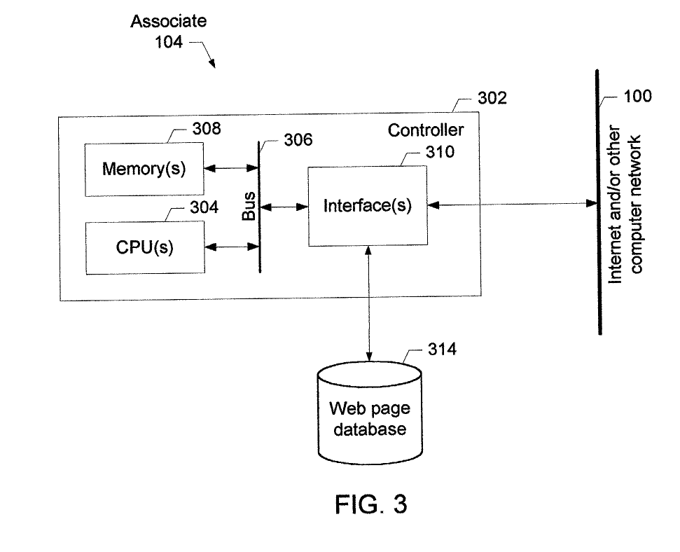

A more detailed diagram of the associate server 104, is illustrated in FIG. 3. A controller 302 in the associate server 104 preferably includes a central processing unit 304 electrically coupled by an address/data bus 306 to a memory device 308 and an interface circuit 310. As with the customer computer 102, the CPU 304 may be any type of well known CPU, such as an Intel Pentium™ processor, and the memory device 308 preferably includes volatile memory and non-volatile memory. The memory device 308 stores a software program that may implement all or part of the method described below. Some of the steps described in the method below may be performed manually or without the use of the associate server 104.

The interface circuit 310 may be implemented using any data transceiver. A storage device 314, in addition to the memory device 308, may be connected to the controller 302 via the interface circuit 310. The storage device 314 preferably stores web pages and/or other content to be delivered to the customer computer 102. In addition, the storage device 314 may store executable software for use in generating content for the customer computer 102. Examples of storage devices 314 include magnetic disks and optical disks such as hard disks and compact disk read only memories (CD-ROMs) The associate server 104 may also exchange data with other computing devices via a connection to the Internet 100. As with the customer computer 102, the connection may be any type of network connection, such as an Ethernet connection.

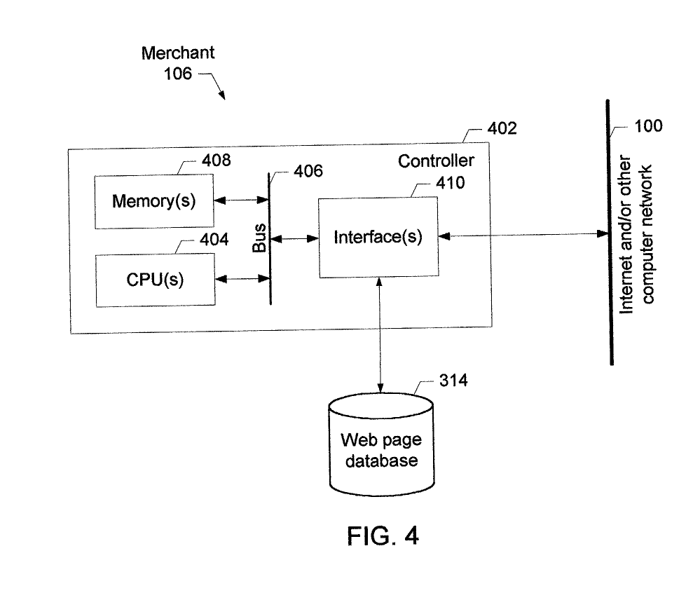

A more detailed diagram of the merchant server 106, is illustrated in FIG. 4. The merchant server 106 may be very similar to the associate server 104, or the merchant server 106 maybe more or less powerful than the associate server 104. Again, a controller 402 in the merchant server 106 preferably includes a central processing unit 404 electrically coupled by an address/data bus 406 to a memory device 408 and an interface circuit 410. The memory device 408 stores a software program that may implement all or part of the method described below. Some of the steps described in the method below may be performed manually or without the use of the merchant server 106.

Again, a storage device 414 may be connected to the controller 402 via the interface circuit 410 to store web pages and/or other content to be delivered to the customer computer 102 and/or the associate server 104. In addition, the storage device 414 may store executable software for use in generating content for the customer computer 102 and/or the associate server 104. The merchant server 106 may also exchange data with other computing devices via a connection to the Internet 100.

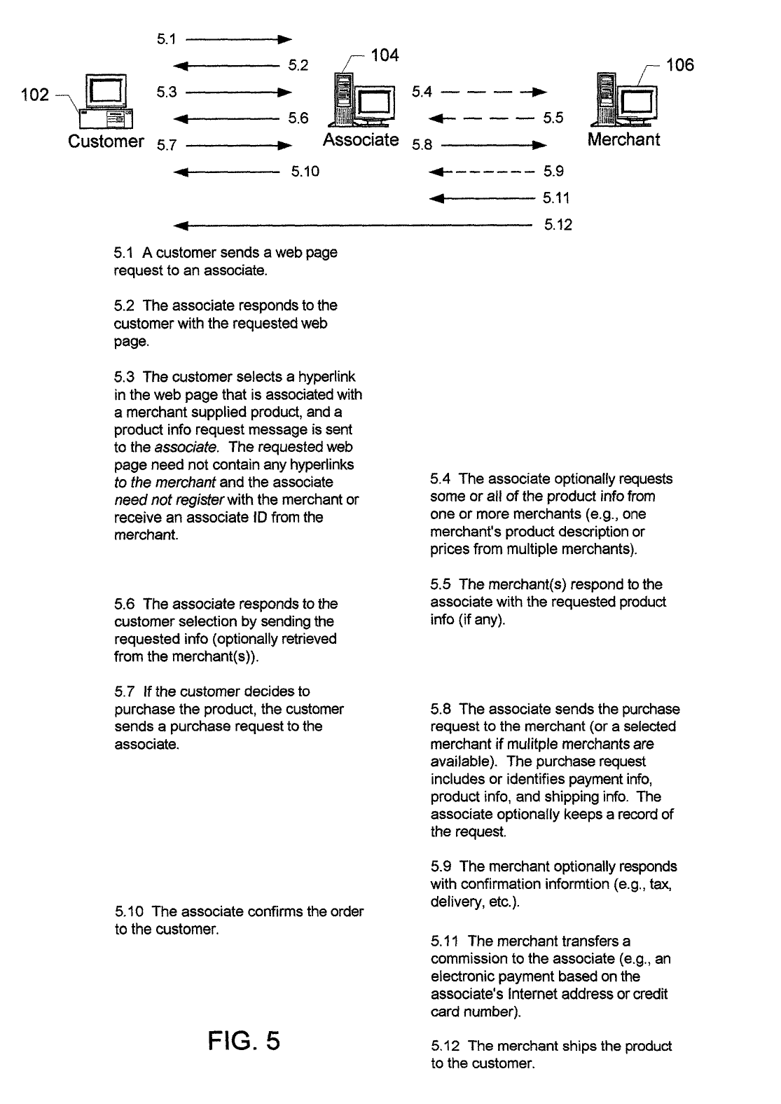

A data flow diagram illustrating a communication sequence for purchasing a product from a merchant on the Internet with the assistance of an associate is illustrated in FIG. 5. The sequence begins when the customer computer 102 sends a web page request to the associate server 104 (step 5.1). Although this description focuses on using hyperlinks to request web pages, a person of ordinary skill in the art will readily appreciate that any type of data request may be used to retrieve any type of digital data in the scope and spirit of the present invention.

The associate server 104 then responds to the customer computer 102 with the requested web page (step 5.2). The requested web page may include hyperlinks that allow the customer to make further requests such as a request for product information and/or a request to purchase a product. The product may be a product associated with an associate, or the product may be a product associated with a merchant. However, the requested web page need not contain any hyperlinks to the merchant server 106. Further, the associate need not register with the merchant or receive an associate ID from the merchant.

When the customer selects a hyperlink in the web page that is associated with a merchant supplied product, the customer computer 102 sends a product information request message to the associate server 104 (step 5.3). The request for product information may simply be a request for another web page stored at the associate server 104.

Alternatively, the associate server 104 may respond to the product a information request message by retrieving some or all of the product information from one or more merchant servers 106 (step 5.4). For example, the product information request message may invoke the execution of software at the associate server 104 that retrieves a photo and a description of a product form a predetermined merchant server 106. In another example, more than one merchant server 106 may be queried for a price (or other variable) associated with the product in order to use the merchant with the lowest price at the time of the request. The software executed at the associate server 104 may be any type of software such as a CGI script, a PERL script, JAVA, C++, etc. If one or more merchant server(s) 106 are queried by the associate server 104, the merchant server(s) 106 respond with the requested product information (step 5.5). Notably, the '141 system may also be improved by having software associated with the associate server 104 select a merchant from a plurality of merchants (e.g., based on product price or availability) prior to embedding the selected merchant's specialized hyperlink in a web page delivered to a customer.

By having the customer computer 102 send the product information request message to the associate server 104 instead of the merchant server 106, the associate maintains greater control over the associate assisted purchase. The associate server 104 may log product information request messages to help the associate better understand the demographics and frequency of such requests. Further, the associate may be compensated by the merchant for each product information request message. Accordingly, the associate may wish to keep his own records of such activities to account for compensation from one or more merchants.

Once the associate server 104 retrieves and/or creates the requested information (locally and/or with the help of the merchant server 106), the associate server 104 responds to the customer computer 102 by sending the requested information (step 5.6). If the customer decides to purchase the product, the customer computer 102 sends a purchase request to the associate server 104 (step 5.7). Typically this request will be performed by selecting a hyperlink, filling out an online purchase order form, and/or confirming previously stored customer information such as the customer's credit card number and shipping address. The purchase request may be sent in response to the receipt of requested product information. Alternatively, the customer computer 102 may send a purchase request based on the web page retrieved in steps 5.1 and 5.2, or the customer computer 102 may send a purchase request based on previously stored information (e.g., from a locally stored catalog of products).

When the associate server 104 receives the purchase request from the customer computer 102, the associate server 104 sends the purchase request (or a similar purchase request) to the merchant server 106 (step 5.8). If the associate server 104 has access to more than one merchant for the requested product, the associate server 104 may choose one of the merchants based on price, delivery, etc. Typically, the purchase request includes or identifies payment information, product information, and shipping information. As described above, the associate server 104 optionally keeps a record of the request for demographic, commission, and/or other purposes. If the purchase request is sent directly from the customer computer 102 to the merchant server 106, the associate must rely on the merchant to report demographics and appropriate commissions.

Once the merchant server 106 receives the purchase request, the merchant server 106 optionally responds with confirmation information such as tax, delivery, etc. (step 5.9). Subsequently, the associate server 104 sends a confirmation of the order to the customer computer 102 (step 5.10).

When a purchase and/or a referral (e.g., a request for product information) is made, the merchant server 106 transfers a commission to the associate based on the associate server's Internet address (step 5.11). Typically, the commission is in the form of financial compensation, but may be any from of value. For example, an electronic payment may be sent via e-mail (e.g., using www.PayPal.com) to an e-mail account associated with the associate. The e-mail address could be derived from the associate server's Internet address which is typically included in all messages from the associate server 104. For example, if the associate's Internet domain is associate.com, electronic payments may be automatically sent to payments@associate.com. Alternately, the associate's e-mail address may be explicitly included in a message from the associate server 104 to the merchant server 106. Or, the merchant server 106 may look up the associate's e-mail address in a database based on the associate's domain name.

In another embodiment, the merchant server 106 may send commission payments to the associate via regular mail. The associate's regular mail address may be determined using a local or publicly available database containing company domain names cross referenced to company mail addresses. Alternatively, the associate's regular mail address may be explicitly included in a message from the associate server 104 to the merchant server 106. Or, the associate's regular mail address may be available on a web page stored at the associate server 104. The address of such a web page may be derived form the associate's domain name. For example, if the associate's domain is associate.com, the web page which includes the associate's regular mail address may be located at www.associate.com/PostalAddress.

In yet another embodiment, the merchant server 106 may credit commission payments to an account belonging to the associate. For example, a credit card account may credited. The account number may be determined using a local or publicly available database. The account number may be explicitly included in a message from the associate server 104 to the merchant server 106. Or, the account number may be available on a web page stored at the associate server 104.

Preferably, the merchant ships the product directly to the customer (step 5.12). However, the merchant may ship the product to the associate. In such an instance, the associate then ships the product to the customer. For example, the associate may combine shipments from several different merchants before shipping the final combination on to the customer.

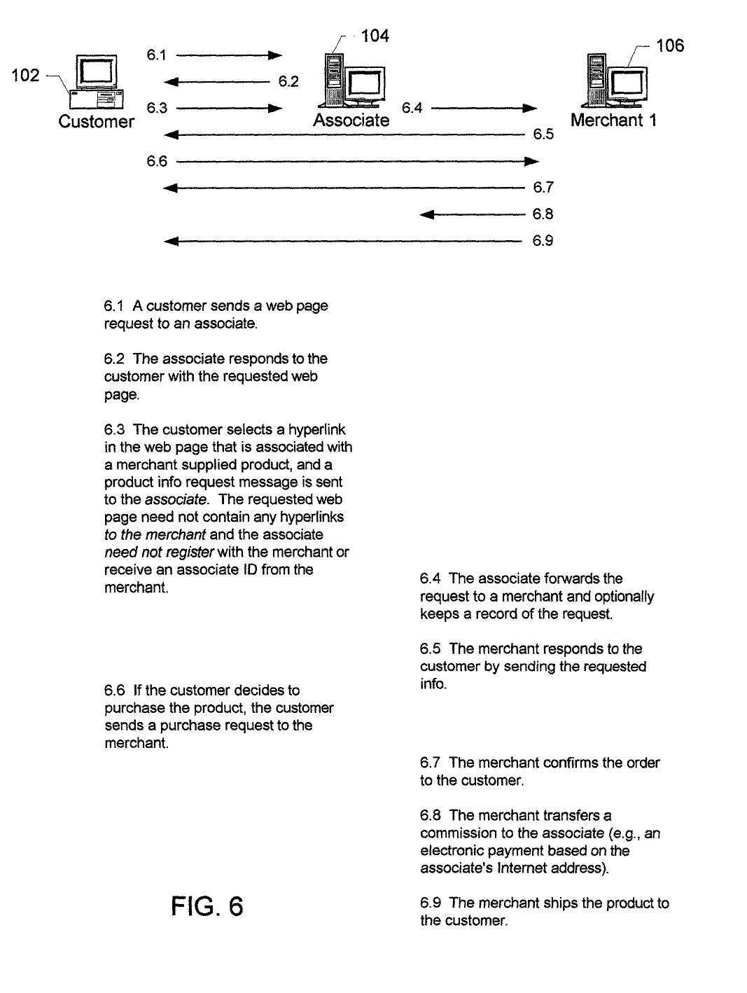

A data flow diagram illustrating another communication sequence for purchasing a product from a merchant on the Internet with the assistance of an associate is illustrated in FIG. 6. As described above, the sequence begins when the customer computer 102 sends a web page request to the associate server 104 (step 6.1). The associate server 104 then responds to the customer computer 102 with the requested web page (step 6.2). Again, the requested web page may include hyperlinks that allow the customer to make further requests such as a request for product information and/or a request to purchase a product. The product may be a product associated with an associate, or the product may be a product associated with a merchant. However, the requested web page need not contain any hyperlinks to the merchant server 106. Further, the associate need not register with the merchant or receive an associate ID from the merchant.

When the customer selects a hyperlink in the web page that is associated with a merchant supplied product, the customer computer 102 sends a product information request message to the associate server 104 (step 6.3). In this embodiment, the associate server 104 then forwards the request (or a similar request) to the merchant server 106 and optionally keeps a record of the request (step 6.4). Subsequently, the customer computer 102 communicates directly with the merchant server 106. In response to the forwarded information request form the associate server 104, the merchant server 106 responds directly to the customer computer 103 by sending the requested information to the customer computer 103 (step 6.5).

If the customer decides to purchase the product, the customer computer 102 sends a purchase request to the merchant server 106 (step 6.6). Typically this request will be performed by selecting a hyperlink, filling out an online purchase order form, and/or confirming previously stored customer information such as the customer's credit card number and shipping address. The purchase request may be sent in response to the receipt of requested product information. Alternatively, the customer computer 102 may send a purchase request based on the web page retrieved in steps 6.1 and 6.2, or the customer computer 102 may send a purchase request based on previously stored information (e.g., from a locally stored catalog of products).

Once the merchant server 106 receives the purchase request, the merchant server 106 responds with confirmation information (step 6.7). When a purchase and/or a referral is made, the merchant server 106 transfers a commission to the associate based on the associate server's Internet address as described in detail above (step 6.8). Preferably, the merchant ships the product directly to the customer (step 6.9).

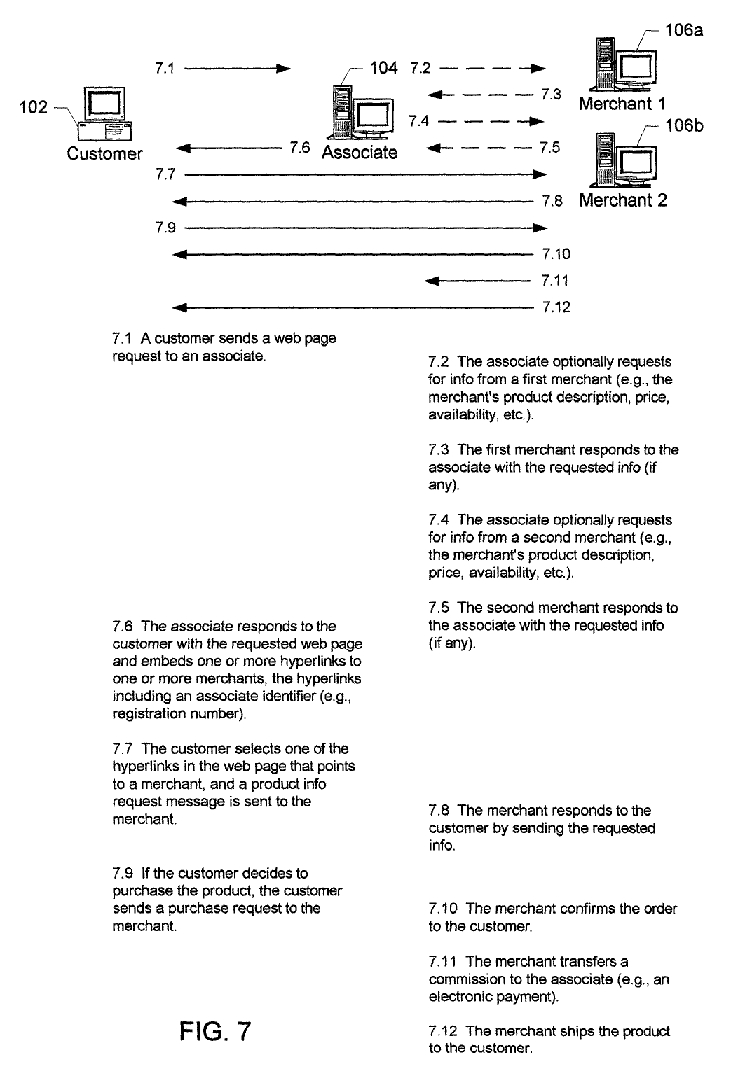

A data flow diagram illustrating a communication sequence for purchasing a product from one of a plurality of merchants on the Internet with the assistance of an associate is illustrated in FIG. 7. As described above, the sequence begins when the customer computer 102 sends a web page request to the associate server 104 (step 7.1). In this embodiment, the associate server 104 eventually responds to the customer computer 102 with a web page which embeds one or more hyperlinks directly to one or more merchant servers 106 (step 7.6). The hyperlinks may include an associate identifier such as a registration number. However, the associate server 104 must first determine which of two or more merchant servers 106 to include in these hyperlinks.

The associate server 104 may make this determination using locally stored data or other data not stored at a merchant server 106. Alternatively, the associate server 104 may send a request for product information (such as a description, price, availability, etc.) to one or more merchant servers 106 which then respond with the requested information (steps 7.2-7.5).

The customer then selects one of the hyperlinks in the requested web page that points to a merchant server 106, and a product information request message is sent to that merchant server 106 (step 7.7). In turn, the merchant server 106 responds to the customer computer 102 by sending the requested information (step 7.8).

If the customer decides to purchase the product, the customer computer 102 sends a purchase request to the merchant server 106 (step 7.9). As described above, this request is typically performed by selecting a hyperlink, filling out an online purchase order form, and/or confirming previously stored customer information such as the customer's credit card number and shipping address.

Once the merchant server 106 receives the purchase request, the merchant server 106 may respond with confirmation information (step 7.10). When a purchase and/or a referral is made, the merchant server 106 transfers a commission to the associate (step 7.11). Preferably, the merchant ships the product directly to the customer (step 7.12).

In any of the above described embodiments, receiving a message may cause the receiving device to communicate with another device. For example, the associate server 104 may send a message to the merchant server 106 in response to receiving a message form the customer computer 102. In such an instance, the associate server 104 may receive a web page request (or other communication) form the customer computer 102. When the associate server 104 detects a particular type of request, it executes software which in turn sends a request to the merchant server 106. The software executed at the associate server 104 may be any type of software such as a CGI script, a PERL script, JAVA, C++, etc. For example, the associate server 104 may embed a hyperlink with an address like www.assocaite.com/execute/merhcantinfo/product=1234. When the user selects such a hyperlink, the associate server 104 executes a software program called “merchantinfo”. The software program “merchantinfo” accepts product=1234 as a parameter. The parameter indicates that the associate server 104 should send a request for information about product 1234 to the merchant server 106.

Any device sending a message to any other device may indicate that the reply is to be sent to another device. In the above example, the associate server 104 may indicate to the merchant server 106 that the response to the information request is to be sent back to the associate server 104, or the associate server 104 may indicate that the response is to be sent directly to the customer computer 102. For example, the associate server 104 may send a web page request to the merchant server 106 like “www. merchant.com/execute/info/product=1234/customer=123.456.789” to indicate that the merchant server 106 should send information (e.g., a web page) about product 1234 to a customer at address 123.456.789. Of course, other protocols could be used to accomplish these results.

In summary, persons of ordinary skill in the art will readily appreciate that a method and apparatus for a customer to purchase a product or service from a merchant with the assistance of an associate has been provided. Systems implementing these teachings allow the associate to automatically earn a commission for and personally track each electronic referral and/or sale. The requested web pages need not contain any hyperlinks to the merchant server and the associate need not register with the merchant or receive an associate ID from the merchant.

In one aspect, the system is directed to a method of selling a particular product via the Internet. The Internet is operatively coupled to a merchant web server, an associate server, and a customer computer. The merchant web server is allied with a first business entity, and the associate server is allied with a second business entity which is different than the first business entity. A product database is provided at the merchant web server and/or the associate server which includes information about the particular product. A product request message may be transmitted from the associate server to the merchant web server. The product request message may include a product identifier and a network address associated with the associate server and/or the customer computer. Information about the particular product may then retrieved from the product database based on the product identifier and transmitted from the merchant web server to the associate server and/or the customer computer. A product order message is transmitted from the associate server and/or the customer computer to the merchant server. The product order message includes or is indicative of a customer shipping address and/or an associate shipping address. Financial compensation is transferred from the first business entity to the second business entity, and the merchant ships the particular product to the customer shipping address or the associate shipping address.

In another aspect, the system is directed to a method of selling a particular product via the Internet The Internet is operatively coupled to a merchant web server, an associate server, and a customer computer. The merchant web server is allied with a first business entity, and the associate server is allied with a second business entity which is different than the first business entity. A product database is provided at the merchant web server and/or the associate server which includes information about the particular product. A product request message is transmitted from the customer computer to the associate web server. The product request message may include a product identifier and a network address associated with the customer computer. Information about the particular product may be retrieved from the product database based on the product identifier. The retrieved information about the particular product is then transmitted from the associate web server to the customer computer. A product order message is transmitted from the associate server to the merchant server. The product order message includes or is indicative of a customer shipping address and/or an associate shipping address. Financial compensation is transferred from the first business entity to the second business entity, and the merchant ships the particular product to the customer shipping address or the associate shipping address.

The foregoing description has been presented for the purposes of illustration and description. It is not intended to be exhaustive or to limit the invention to the precise form disclosed. Many modifications and variations are possible in light of the above teachings.

What is claimed is:

1. A method of selling a particular product via the Internet, the Internet being operatively coupled to a merchant web server, an associate computer, and a customer computer, the merchant web server being allied with a first business entity, the associate computer being allied with a second business entity, the first business entity being different than the second business entity, the method comprising the steps of:
providing a product database at the merchant web server, the product database including information about the particular product;
receiving a product request message at the merchant web server from the associate computer, the product request message including a product identifier and a network address associated with the associate computer;
retrieving information about the particular product from the product database based on the product identifier;
transmitting the retrieved information about the particular product from the merchant web server to the associate computer;
receiving a product order message from the associate computer, the product order message being indicative of a customer shipping address;
transferring financial compensation from the first business entity to the second business entity; and
shipping the particular product identified by the product identifier to the customer shipping address.

2. A method of selling a particular product via the Internet, the Internet being operatively coupled to a merchant web server, an associate computer, and a customer computer, the merchant web server being allied with a first business entity, the associate computer being allied with a second business entity, the first business entity being different than the second business entity, the method comprising the steps of:
providing a product database at the merchant web server, the product database including information about the particular product;
receiving a product request message at the merchant web server from the associate computer, the product request message including a product identifier and a network address associated with the associate computer;
retrieving information about the particular product from the product database based on the product identifier;
transmitting the retrieved information about the particular product from the merchant web server to the associate computer;
receiving a product order message from the customer computer, the product order message being indicative of a customer shipping address;
transferring financial compensation from the first business entity to the second business entity; and
shipping the particular product identified by the product identifier to the customer shipping address.

3. A method of selling a particular product via the Internet, the Internet being operatively coupled to a merchant web server, an associate computer, and a customer computer, the merchant web server being allied with a first business entity, the associate computer being allied with a second business entity, the first business entity being different than the second business entity, the method comprising the steps of:
providing a product database at the merchant web server, the product database including information about the particular product;
receiving a product request message at the merchant web server from the associate computer, the product request message including a product identifier and a network address associated with the customer computer;
retrieving information about the particular product from the product database based on the product identifier;
transmitting the retrieved information about the particular product from the merchant web server to the customer computer;
receiving a product order message from the associate computer, the product order message being indicative of a customer shipping address;
transferring financial compensation from the first business entity to the second business entity; and
shipping the particular product identified by the product identifier to the customer shipping address.

4. A method of selling a particular product via the Internet, the Internet being operatively coupled to a merchant web server, an associate computer, and a customer computer, the merchant web server being allied with a first business entity, the associate computer being allied with a second business entity, the first business entity being different than the second business entity, the method comprising the steps of:
providing a product database at the merchant web server, the product database including information about the particular product;
receiving a product request message at the merchant web server from the associate computer, the product request message including a product identifier and a network address associated with the customer computer;
retrieving information about the particular product from the product database based on the product identifier;
transmitting the retrieved information about the particular product from the merchant web server to customer computer;
receiving a product order message from the customer computer, the product order message being indicative of a customer shipping address;
transferring financial compensation from the first business entity to the second business entity; and
shipping the particular product identified by the product identifier to the customer shipping address.

5. A method of selling a particular product via the Internet, the Internet being operatively coupled to a merchant web server, an associate computer, and a customer computer, the merchant web server being allied with a first business entity, the associate computer being allied with a second business entity, the first business entity being different than the second business entity, the method comprising the steps of:
providing a product database including information about the particular product;
receiving a product request message at the associate web server from the customer computer, the product request message including a product identifier and a network address associated with the customer computer;
retrieving information about the particular product from the product database based on the product identifier;
transmitting the retrieved information about the particular product from the associate web server to the customer computer;
transmitting a product order message from the associate computer to the merchant server, the product order message being indicative of a customer shipping address;
transferring financial compensation from the first business entity to the second business entity; and
shipping the particular product identified by the product identifier to the customer shipping address.
